(19) United States
(12) Patent Application Publication
(10) Pub. No.: US 2010/0301610 A1
(43) Pub. Date: Dec. 2, 2010

(54) Aperture engine

(76) Inventor: Enrique H. LEON, Guatemala (GT)

Correspondence Address: ENRIQUE H,LEON RABANALES, 29 AVENIDA 27 - 79 ZONA 5, GUATEMALA, GT

(21) Appl. No.: 12/475,495

(22) Filed: May 30, 2009

(51) Int. Cl. H02K 7/18; F03B 13/00

(52) U.S. Cl. 290/54; 60/398

(57) ABSTRACT

A hydro pneumatic engine, providing rotational energy at very low RPM, proper to drive an electric generator directly coupled, using as power supply atmospheric pressure variations, originated by vacuum coming from an oscillating wave chamber. With dynamic variable resonance for marine working environment, low internal friction, few mechanical internal reactions and low level noise, this devise operates with potential/kinetic energy multiple conversions and uses as torsion converter a similar unbalanced turbine mechanism, with modified movement, of external zero flow and outstanding minimum head pressure with non corrosive recycling liquid; works offshore or shore line, including also indoor or basement locations, even works with some lakes and with some rivers also without any dam requirement, being as such an environmentally low impact design.

### FIELD OF INVENTION

This engine is related with the hydro pneumatic engines.

Also is related with hydraulic engines.

### DESCRIPTION OF THE PRIOR ART

Mankind eternal energy search, since long time ago, has tried capturing oceanic energy, where there are powerful Nature forces, stored by astronomic influences.

For such objective, has been limited success but mostly are faced with sea environment, taping some energy amounts. But sooner or later, at large, such attempts are destroyed, by an ever winner environment.

And design requirements, cannot allow extensive use of sea power.

Mostly times, with some exceptions, can be observed that:

Relatively expensive methods are used, exposed at hard sea conditions.

Few geographic locations are available, by consequences of design requirements.

Invading at sea environment, where Nature forces conspire against stability of devices and rigs installations.

High-level technologies are necessary. Not all nations have it.

Designs are almost times, rigid, without flexibility, which is very interesting characteristic to adapt at ever changing sea behaviour.

High maintenance costs, produced by complex necessities of mostly methods used today.

Most methods uses compressor and turbines, that means air or salt water great volumes. calling for high pressure (big sea waves) and big non-corrosive equipment.

Another methods requirements are not simple to build operate or keep running, being mostly fixed rigs, huger, hard to transport in emergency situations.

Today designs are relatively passives, with limited use of technology advances, especially into electronic and informatics fields.

### SUMMARY OF INVENTION

Accordingly, many previous disadvantages mentioned are remedy in my invention.

Some objects y advantages are:

In general, is a design of relative low cost to make. Can operate offshore or shoreline, admits underground mounting, including in home or buildings, because low noise level, fuel free, cool cycle and low losses in power feed pipeline.

Low peak-to-peak wave requirement; let location on many places around world beaches.

Environmentally non-invasive design, with landscape low visual impact, and can also operate in rivers, without dams.

This devise can be built including low pressure and low cost materials, as wood or plastic, both marine weather resistant and available in almost place.

Dynamically flexible design admits wide range operating parameters, more adequate at changing Mother Nature, because his automation ready disposition.

Advantageous double duty use of electronic parts, controlling the mechanical aspects of engine and at same time, making tasks over electrical loads. Thus optimizing the external input power available any time. It is very important item in small electric grids.

Operation and maintenance costs very low relatively, because engine is made with commons materials and by its simple mechanical design. Also telemetric surveillance and remote re-programming is possible.

Learning curve for training, installers and maintenance people, is very simple.

Stackable, units can be installed using few space and at different buildings levels.

Portability by his low weight and low space storage requirement, easy shipping and handling, fast in place installing, and easy transport, air way included, for entertainment, work or in case of natural disasters, as emergency power plants.

### BRIEF DESCRIPTION OF DRAWINGS

FIG. 1 (Front page suggested) shows in a two-point perspective, the entire engine. Elbows (1401) are detached of reactor (10), only for best picture understanding. For it reason, hose (1418) and associated parts are not showed here. (See FIG. 6).

FIG. 2 shows exploded view of slave beam (3).

FIG. 3 shows the lateral view of mass (5) set. Front view in FIG. 3 (A) and the lateral view of mass (5) in FIG. 3(B).

FIG. 4 shows exploded view of master beam (6) and his all parts.

FIG. 5 Isometric view of Reactor (10) and FIG. 5(A) let see the inside unique perforated bar.

FIG. 6 shows how Reactor (10) and Strap (14) set are connected each other. Also shows all plumbing associated parts.

FIG. 7 front view of Follower tank (13), his lateral view in FIG. 7 (A) and cut view in FIG. 7(B) I-I.

FIG. 8 depict front view of Sandbox tank (18), FIG. 8(A) lateral view And FIG. 8 (B) I-I is cut view showing three compartments.

FIG. 9 show front view of Anchor tank (21), with attached pump (2102), FIG. 9 (A) I-I show his cut view, FIG. 9 (B) is a lateral view showing the pump motor (2105) and FIG. 9 (C) I-I is a cut showing the central handle wall.

FIG. 10 shows lateral view of electric Generator (2) with all associated parts with axes (0207). FIG. 10 (a) shows the Jar (1), FIG. 10 (b) shows chain adapter (0203) details, and FIG. 10 (c) I-I shows the cylinder Jar (1) cut.

FIG. 11 shows isometric view of Top Plate Support (25) with his associated parts.

FIG. 12 is a schematic showing in one same plane, simplified view of both beams and related parts. Components are in caliper position.

FIG. 12 (a) is a schematic showing set-up position.

FIG. 12 (b) is a schematic showing start cycle position.

FIG. 12 (c) is a schematic showing at half cycle.

FIGS. 13, (a), (b), (c) shows in schematic form, actuator movement, (reactor and transfer balance).

FIG. 13 (d) is an amplified and detailed picture of small associated components.

FIG. 14 and FIG. 14 (a) show how hydraulic actuator works.

FIG. 15 is a schematic diagram of pumping system.

FIG. 16 is a perspective of Axis (4) for tap rotational energy.

FIG. 17 is a suggested portable base structure, for Aperture.

FIGS. 18, (A), (B) shows electromagnetic ratchet parts.

FIG. 19 and FIG. 19 (A) I-I shows self-siphoning tank and his cut.

### DETAILED DESCRIPTION OF THE INVENTION

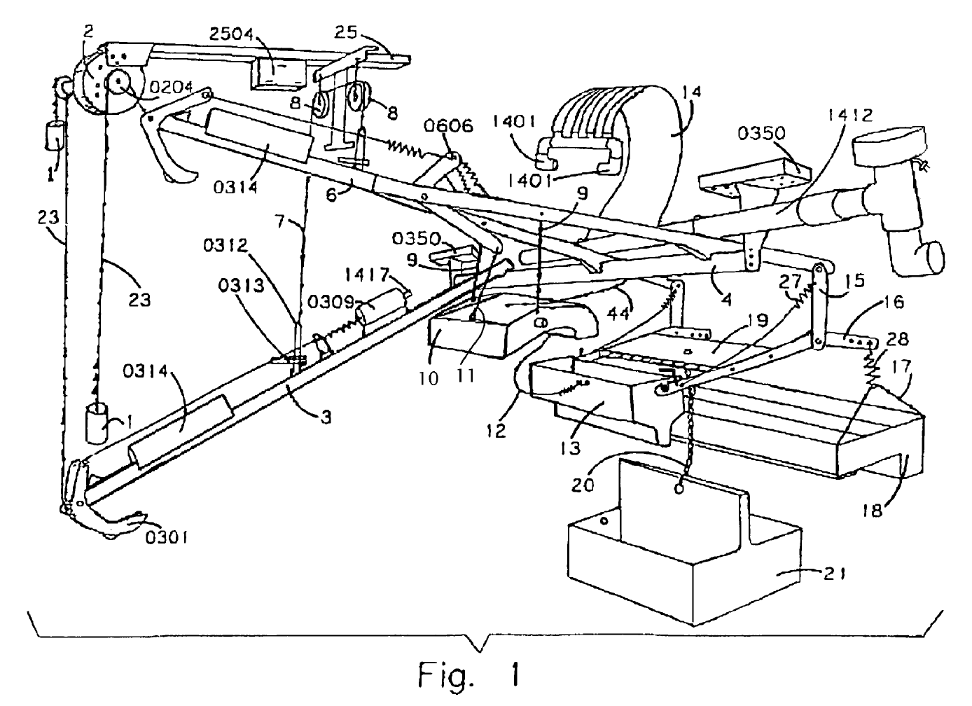

Atmospheric Potential Energy Reactor, a three unbalanced radii energizer engine (A.P.E.R.T.U.R.E. engine or Aperture, for short) see FIG. 1, is an engine using the vacuum coming mainly from an oscillating wave chamber (O.W.C.), (not showed), preferably located on the sea to displace liquid weight, thanks in site atmospheric pressure reaction, along a reciprocating beams system, to accumulate potential energy, driving counterweights jars (1), in alternating sequence to produce basically, ratchet rotational movement for a dual shaft electric generator (2).

Vacuum use allows O.W.C. remote location, with advantageous low losses in the pipeline (not showed), letting also onshore devise installation. Being a low-pressure device, is possible build it including parts of plastics or wood.

The engine consists of:

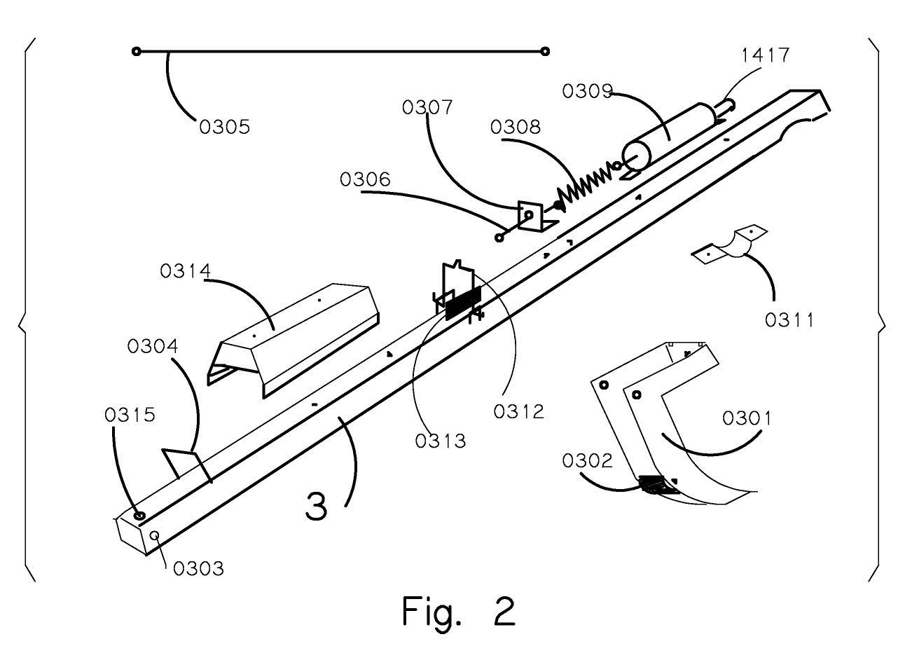

A SLAVE BEAM (3), which is the first radius, (see FIG. 2) has a shock absorber made of an angled dual bar (0301) with internal rod (0302), riveted in hole (0303), (rivet not showed) with stop hook (0304), cable (0305), short bar (0306), guide (0307), and spring (0308) connected at vacuum piston pump (0309). This beam (3) is rod supported near one end, at fixed axis tube (4) (showed in FIG. 1) with clamp (0311), has a chain hook (0312) with sensor plate (0313) and also has a cover (0314) nesting a shifting mass (5) set.

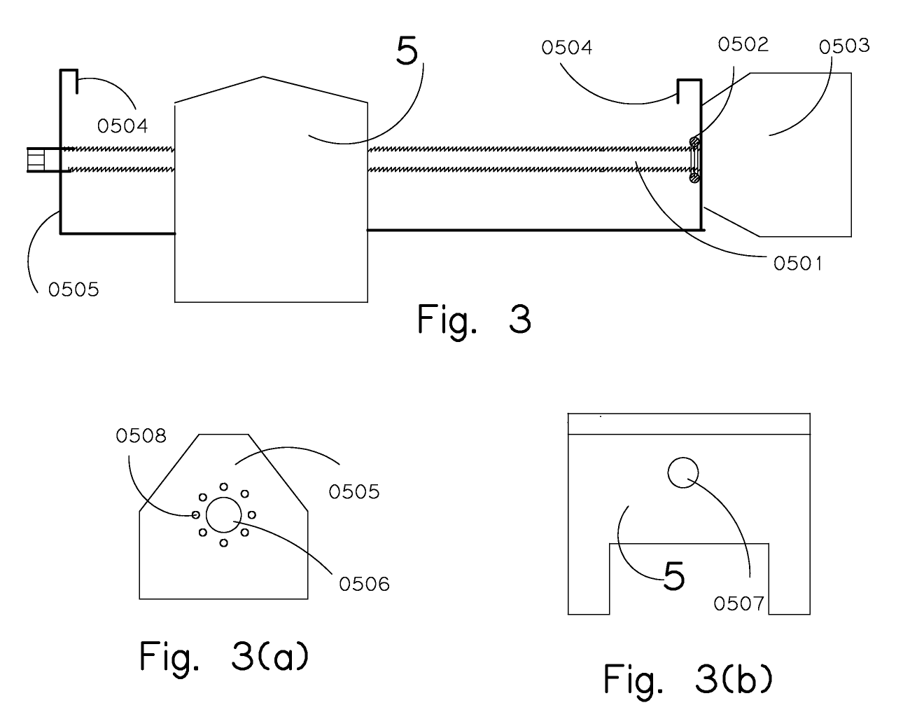

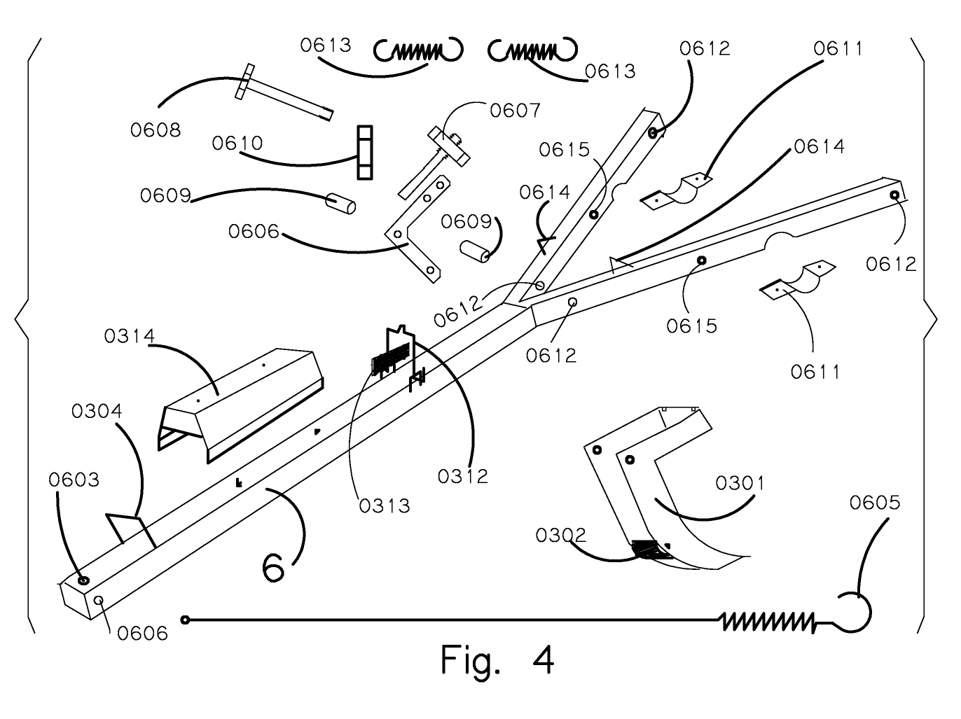

FIG. 3 show the mass (5) set, with long screw (0501), O-ring (0502), small stepper motor (0503) with internal reduction gear box (not showed), plate bench (0505), with sensor supports (0504).

FIG. 3(a) shows lateral view of bench plate (0505), long screw grommet hole (0506) (grommet and motor screws not showed) and fixing motor holes (0508).

FIG. 3(b) shows lateral view of mass (5) and his internal threaded hole (0507).

A MASTER BEAM (6), showed in FIG. 4, split in one end, seems as a letter Y. In this split beam-ends is rod supported, forming a short radius and a long radius. Clamps (0611) keeps on fixed axis tube (4), (this manner, long radius and first radius are almost parallel in FIG. 1), having shock absorber made of an angled dual bar (0301) with internal rod (0302), riveted in hole (0606), (rivet not showed), with stop hook (0304), a cable with spring (0605) attached at a levitator lever, made up with an angled bar (0606), (could be soldered with an auxiliary mass adjust set (0607) showed only here)), oscillating over an axis formed with bolt (0608), centering tubes (0609), nut (0610), located in holes (0612) and two springs (0613) fixed at triangular hooks (0614).

Also has another cover (0314) which nest a shifting mass (5) set, and sensor plate (0313) with chain hook (0312) which has a coupling chain (7) (see FIG. 1) supported with two pulleys (8) going at the other chain hook (0312) in slave beam (3).

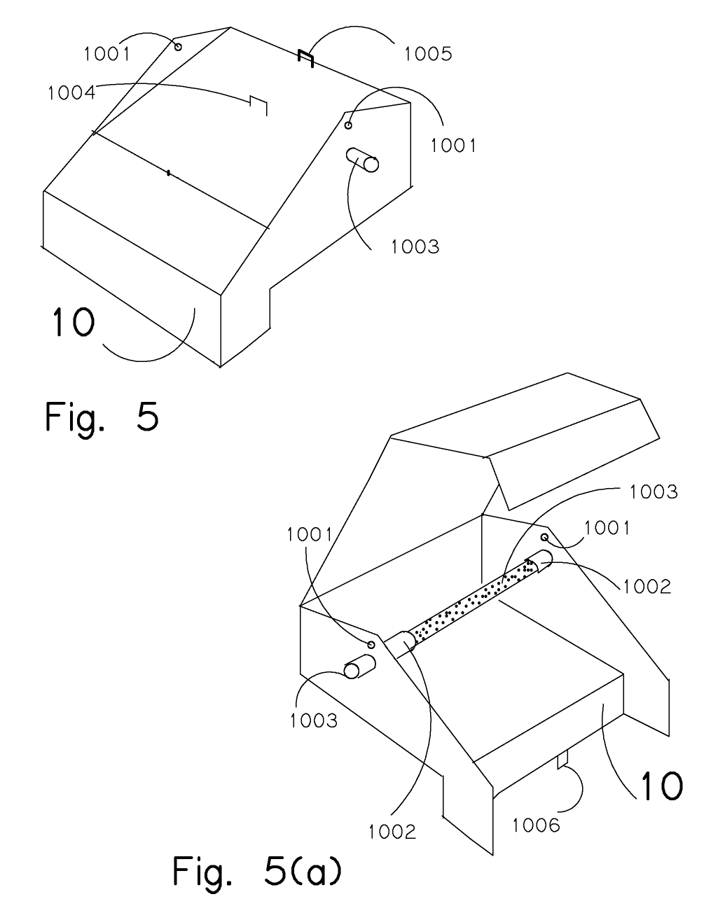

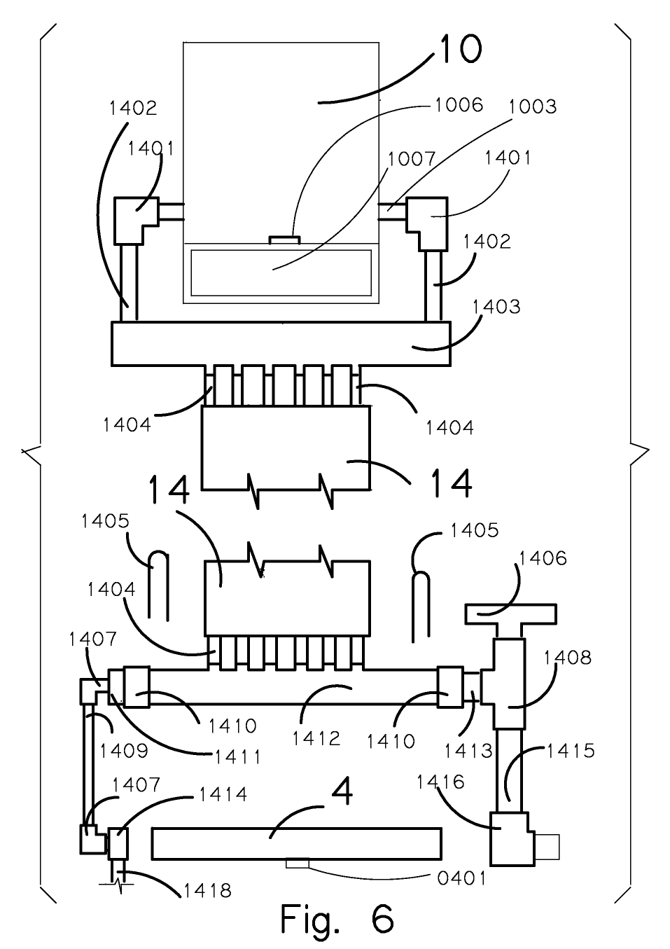

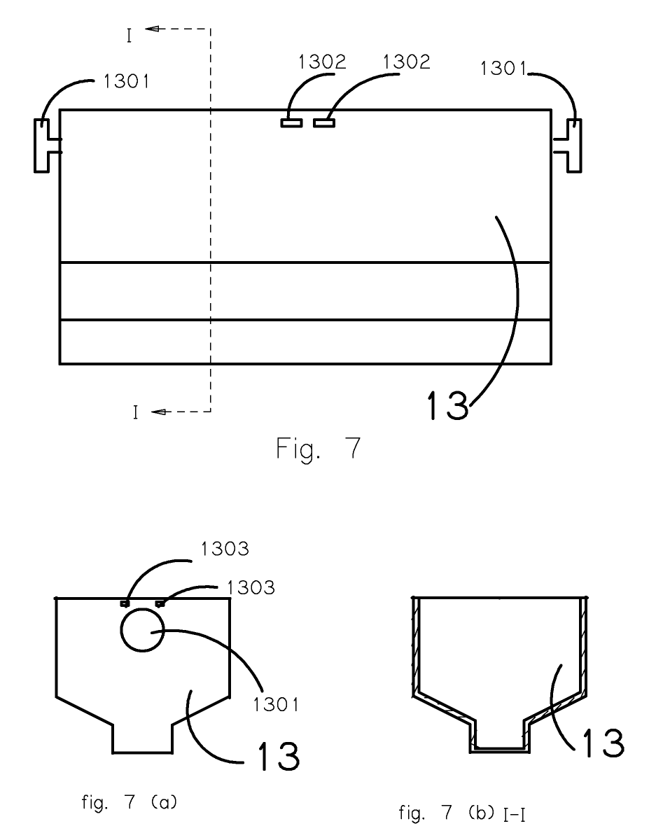

A HYDROPNEUMATIC ACTUATOR, which is basically a charge oscillator producer, built with two main elements: a Reactor (10), showed in FIG. 5 and a Transfer Balance is detailed in FIGS. 1, 7,8,9 and 13 (including his variants).

The REACTOR (10) is a leaning rectangular chamber, elongated box form, with an inverted inlet area (1007), (in FIG. 6). FIG. 1 shows under master beam (6) from holes (0615), hanging two chains (9) at holes (1001) in reactor (10) (see FIG. 5). Chain (11) couples hook (1005) with levitation lever (0606) and chain (44) couples hook (1004) at axis tube (04) hook (0401), (showed in FIG. 6) or can be loosely tied around axis tube (4).

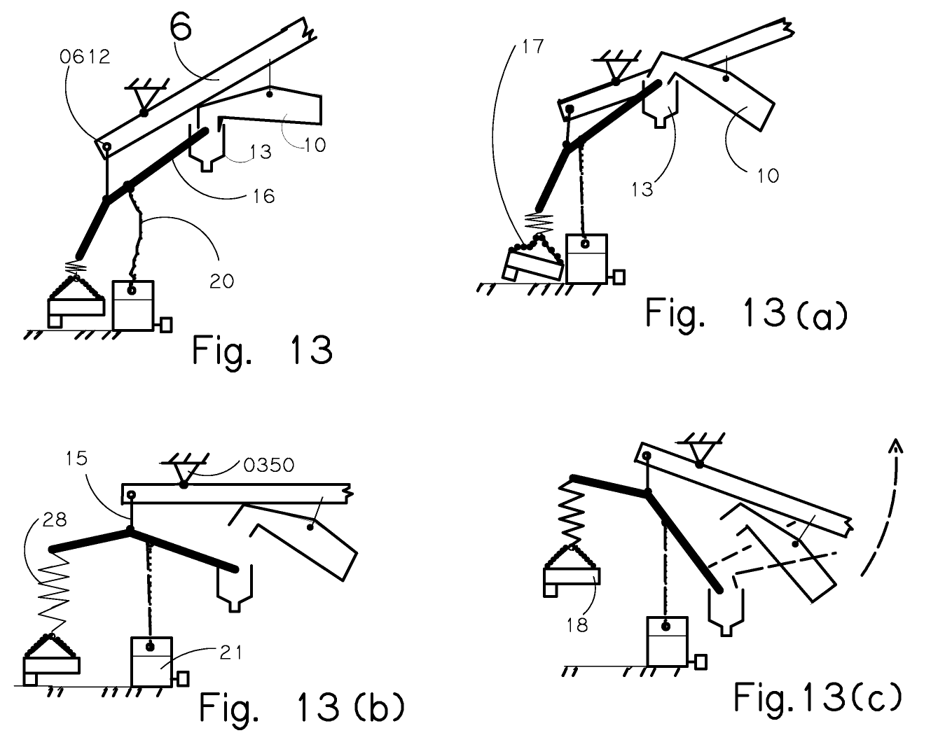

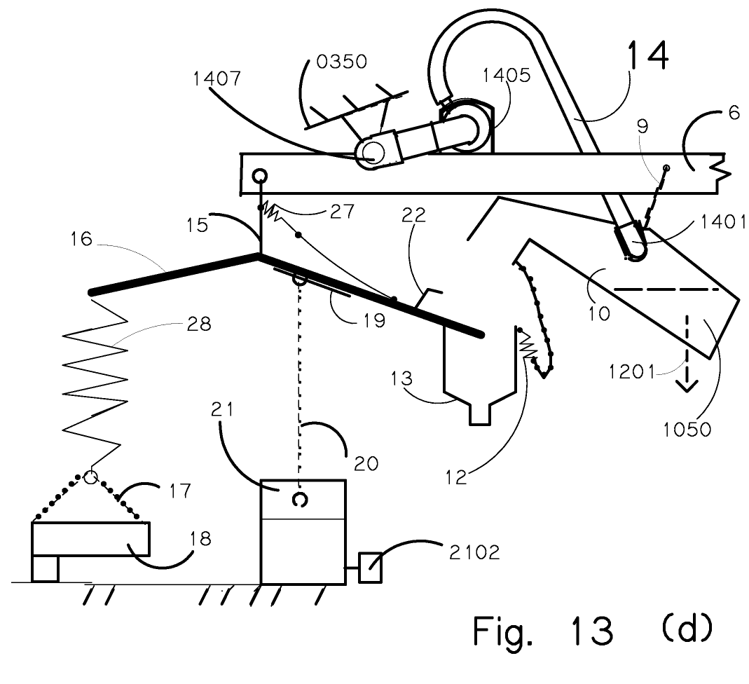

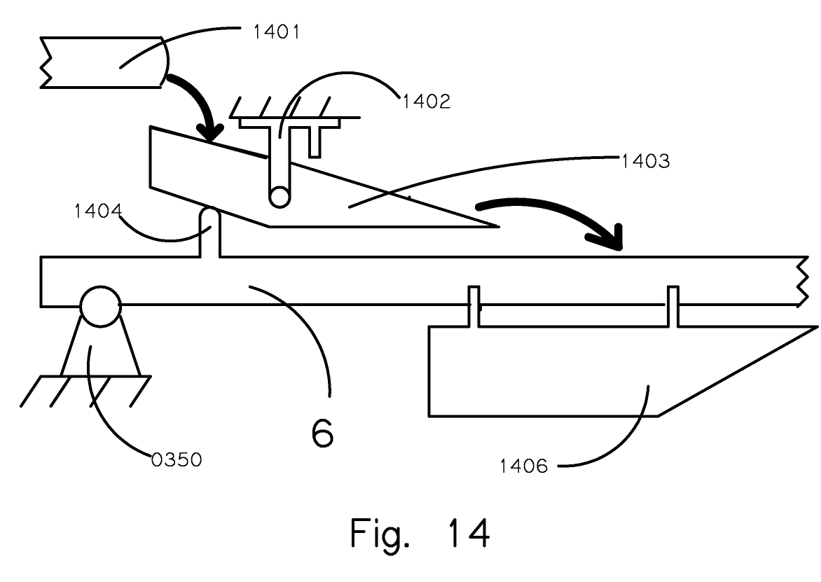

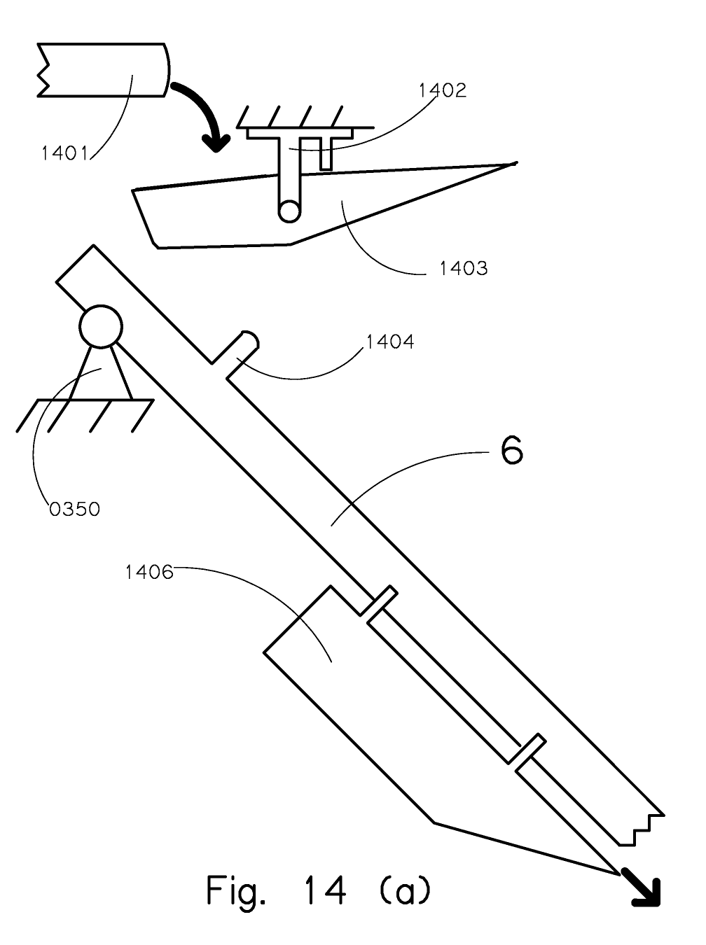

Semi assembled Reactor (10) view in FIG. 5(a), show the unique element inside which is a protruding perforated tube (1003), with rotating sealing (1002) near at each end. Also shows hook (1006) for cable with spring (12) for auxiliary pulling from follower tank (13) slot (1302), (explained later, in FIG. 13(d)). In FIG. 6, reactor (10), bottom view, through tubes (1003) is coupled at vacuum strap (14) through elbows (1401) and short tubes (1402), at manifold (1403).

The vacuum strap (14) set, has several small diameter hoses (1404), over a flexible material layer (not showed) with two manifolds (1403,1412) at the ends. Manifold (1412) left output (in FIG. 6), has a couple (1410), a reducer with internal check valve (1411), an elbow (1407), short small diameter tube (1409), elbow (1407), a rotating sealing (1414) with hose (1418) going toward inlet (1417) of vacuum pump (0309), (in FIG. 2). (Not showed). (When periods (1/f) are too short, check valve (1411) could be placed inside inlet (1417)).

Manifold right output (1412) has a couple (1410), a reducer (1413), with a tee (1408), vacuum sensor (1406), short tube (1415) and an elbow with internal rotating sealing (1416), which is the input of pipeline (not showed) coming from O.W.C. (not showed). Both rotating sealing (1414,1416) must be near concentric with axis tube (4) as possible, specially (1416).

Manifold (1412) must be enough larger than axis tube (4), to avoid interference, and attached with clamps (1405) on master beam (6). Vacuum strap (14) layout is showed in FIG. 13 (d), where pass between split parts of master beam (6).

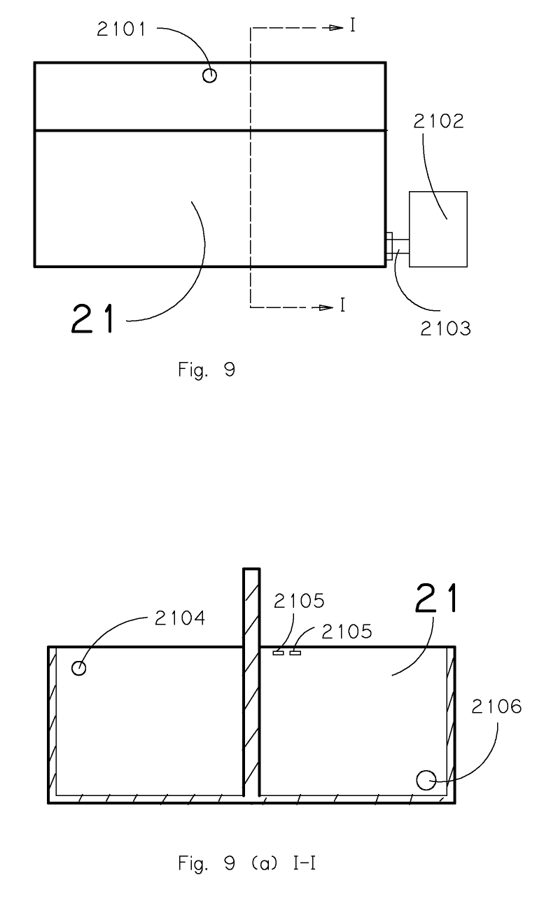

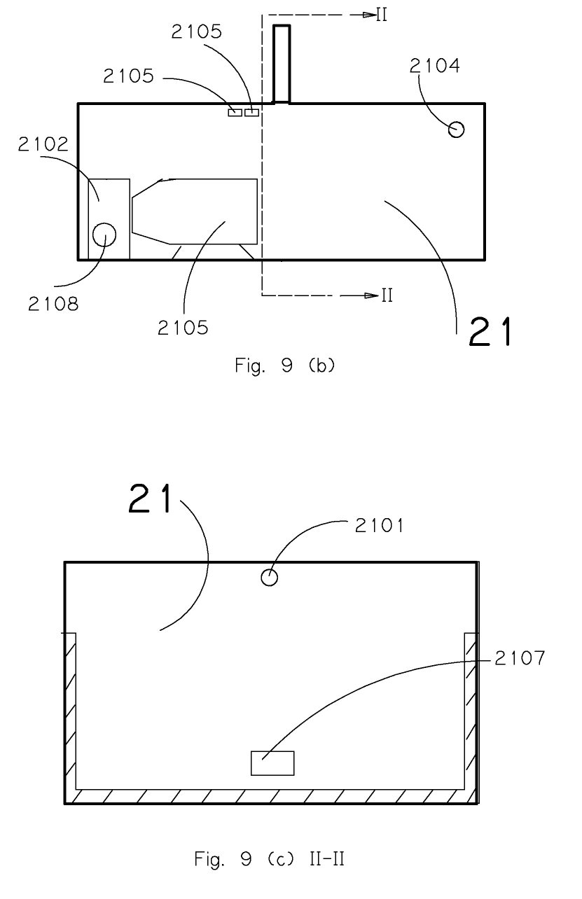

The TRANSFER BALANCE is showed in FIG. 1, hangs from both holes (0612) in master beam (6) (short radius split ends), vertical bars (15), holding two angled bars (16) with hooks ends to support follower tank (13) and also supports with springs (28) and chains (17) a sandbox tank (18). Also there is a chain (20), coupling the plate (19) bottom, with below anchor tank (21) hole (2101), (in FIG. 9). There are also, from vertical bars (15) near top end, auxiliary cables with springs (27) attached at angled bar (16) end near follower tank (13), where also are little angled stopper bars (22). (See FIG. 13 d).

The Follower Tank (13) is detailed in FIG. 7, having two holding short axes (1301); two slots (1302) for overflow and for attach cable with spring (12). FIG. 7(a) shows two slots (1303) for hold a little diameter hose (not showed) and level sensor (not showed). And FIG. 7 (b) I-I, show inside simplicity of container.

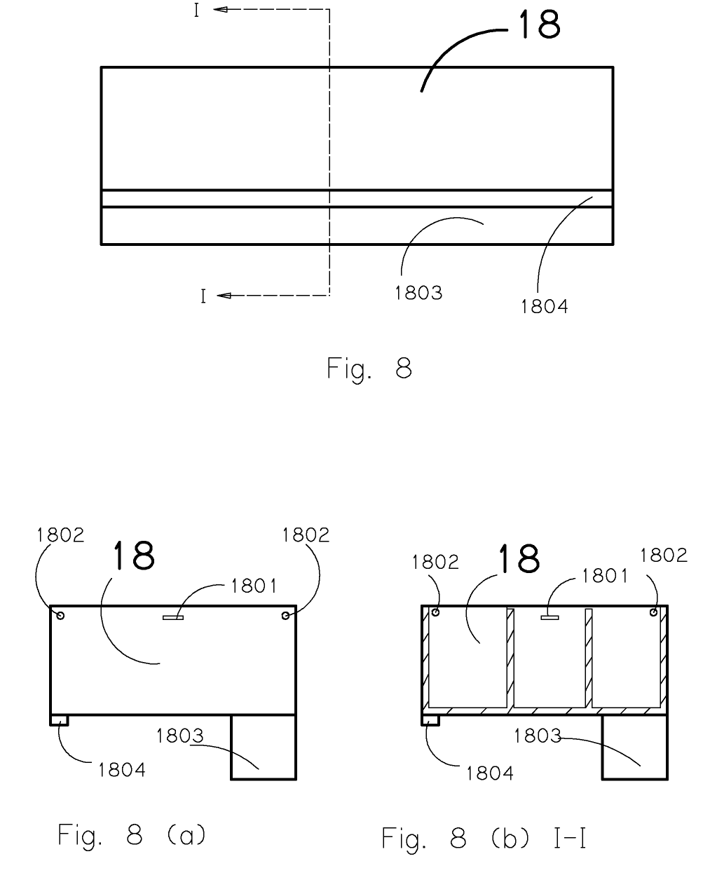

The Sandbox Tank (18) form is showed in FIG. 8. FIG. 8(a) shows chains (17) holder holes (1802); overflow slot (1801) and cushioning blocks (1803,1804) made of flexible material.

And FIG. 8 (b) I-I shows another two chains (17) holder holes (1802) and also shows that sandbox has two compartments for solid ballast (sand) and a central liquid container, with another slot (1801) as sensor/hose holder, (hose and sensor not showed). All these compartments are hole connected each other (holes not showed).

The Anchor Tank (21) is showed in FIG. 9. Have a chain hole (2101) and a small bi-directional pump (2102) with union fitting (2103). FIG. 9 (a) I-I shows overflow hole (2104), slots (2105) for hose/sensor (not showed) and water duct (2106) for bi-directional pump (2102). FIG. 9(b) shows location of a bi-directional pump (2102), his electric motor (2105) and pumping input/output duct (2108). And FIG. 9(c) II-II shows the big slot (2107) for water passage between tank compartments.

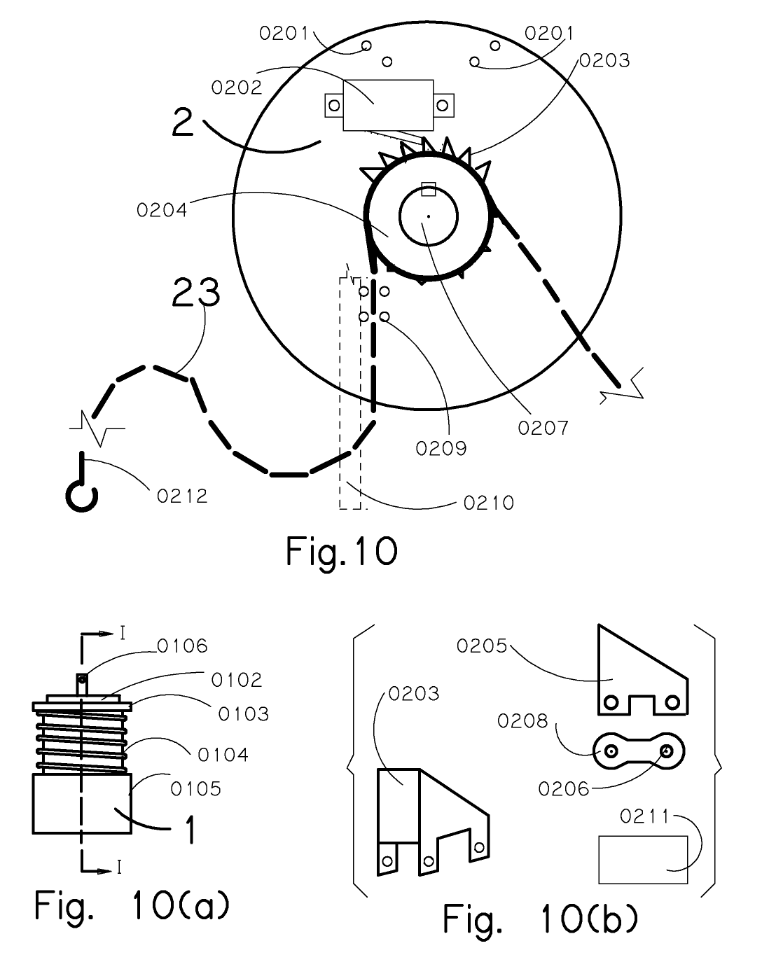

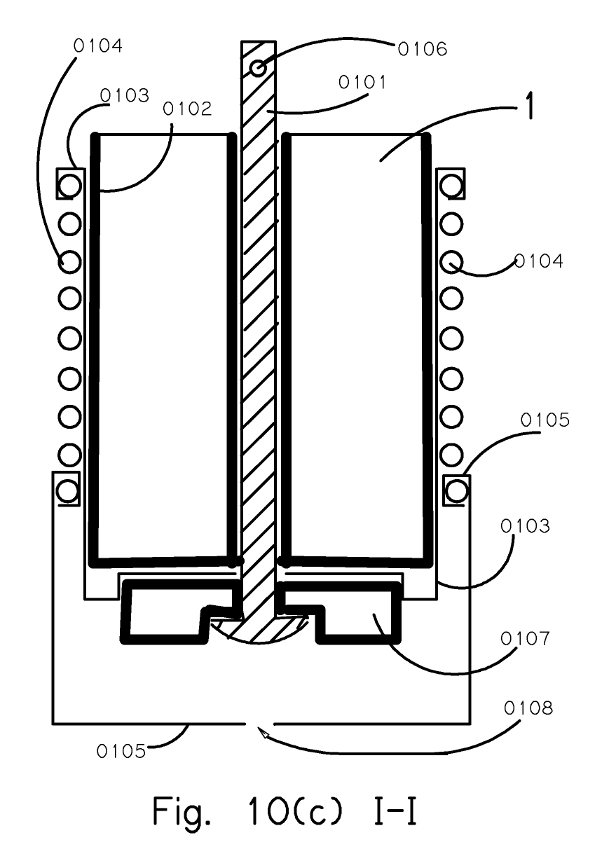

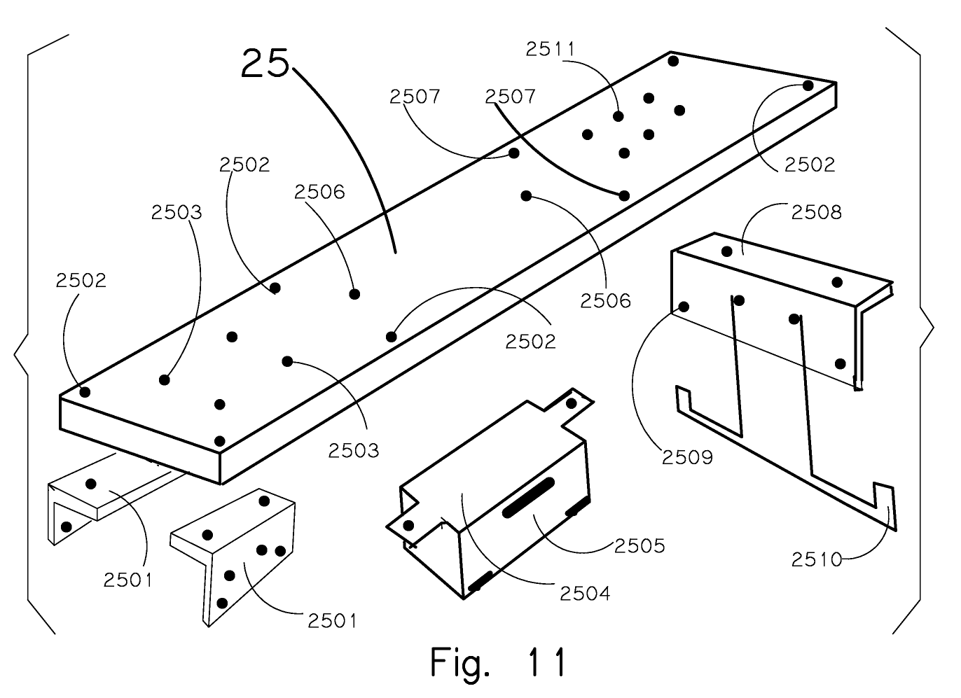

AN ELECTRIC GENERATOR (2), with dual axis (FIG. 10), which has in each side, four holes (0201) for support at brackets (2501) (showed in FIG. 11), four holes (0209) to hold level sensor (not showed) and a small diameter hose (not showed). Part of this hose is showed in phantom view (0210) to remark how hose end must reach near jar (1) bottom inside, when it is near sprocket (0204). (In this way, short time pumping can take place when any jar is stationary in up position, during cycle).

Chain hook (0212) must be attached at hole (0106) of cylindrical jar (1) in FIG. 10 (a), where shows cushion spring (0104), inner jar (0102), external cover (0103) and bottom cup (0105) of the jar (1). FIG. 10(c) I-I also shows internal parts of jar (1) as bolt (0101), inner jar (0102) with central liner, mass (0107) and a drain hole (0108).

Parts (0103), (0101) and (0107) must be tied together, otherwise will be necessary to put a spring (not showed) with two flat washers (not showed) over the bolt (0101) top end, with chain hook (0212) pressing.

The electric generator (2) supports (in both axis) a temporary storage arrangement of potential energy. Which is made with of two counterweights jars (1) and two chains (23), (FIG. 1) fixed at holes (0315, 0603) at the ends of both beams (see FIGS. 2 and 4)). In FIG. 10 is showed how chains (23) are supported with sprockets (0204), with internal ratchet, which drives the generator (2) dual axis (0207), when both cylindrical jars (1) are going down, alternately, when solenoids triggers (0202) are operated. (Sprocket tooth are deemed, for remark chain adapters (0203)).

Solenoid trigger ratchet action happens when solenoid trigger (0202) is no energized, with chain adapters (0203) in position, detailed in FIG. 10 (b). Also in this figure we can see adapter isometric view (0203), adapter top view (0211); lateral view (0205) over a chain link part (0208) with rivet (0206) of chain (23). Only few adapters (0203) are needed, near each chain trigger zone, which jar (1) is in upper dead point.

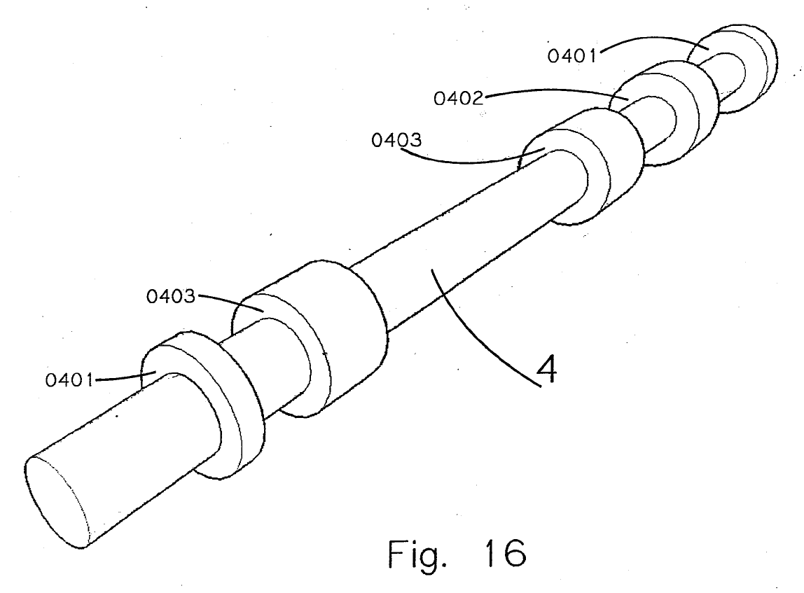

A TOP PLATE SUPPORT (25), requiring six fixing points (2502) is showed in FIG. 11. Four located at the piece corners and two more near the generator (2) brackets (2501), these brackets are located under four points (2503); an electronic box (2504) has a service gate (2505) with puller and hinges, disposed to nest electric (not showed) and electronic parts (not showed), (computer, controller, back up battery, etc) and must be positioned under two points (2506). Holder piece (2508) is attached under points (2507) where pulleys (8) (FIG. 1) hangs in points (2509) and sensors (not showed) for plates (0113,0313) can be tied in (2510), (see also FIG. 1). And six points (2511) are disposed to tie under, a manifold (not showed), four solenoid valves (not showed) and a Y filter (not showed). Plumbing parts will show detailed in schematic FIG. 15 later.

FIG. 13 (d) shows many small details, in rough sketch, schematic form. Vacuum strap (14) routing, with clamp (1405) over master beam (6), elbow (1401) attached at reactor (10), elbow (1407) in concentric position with axis tube (4). Remarks also a little angled stop bar (22), which avoids penetration of reactor (10) during liquid discharge into follower tank (13).

Also remarks an auxiliary cable with spring (12) which gives additional pulling force for start discharge reactor (10) liquid (1050), when reactor (10) and transfer tank (13) are at maximum separation. And, (see FIG. 13 (c)) before levitation lever (0606) pulling action, which happens when master beam (6) end touches the floor. (Phantom arrow denotes force (1201) in gravity center of such liquid (1050)).

All engine can be assembled using screws, soldering, nails, glue, tied, hooks, etc. (all these not showed), because some engine parts could be plastic or wood material.

A PROTECTING WEATHER STRUCTURE (not showed), (especially for jars (1) wind protection) which also must provide all necessary supporting for adequate engine operation. In some cases, use of axis (4) could be neglected, modifying axis supports (0350) (not showed).

All plumbing and electrical layout is not showed here, because it depends on supporting structure container form. Axis tube (4) supports (0350) showed in aerial position (in FIG. 1), only for best drawing understanding.

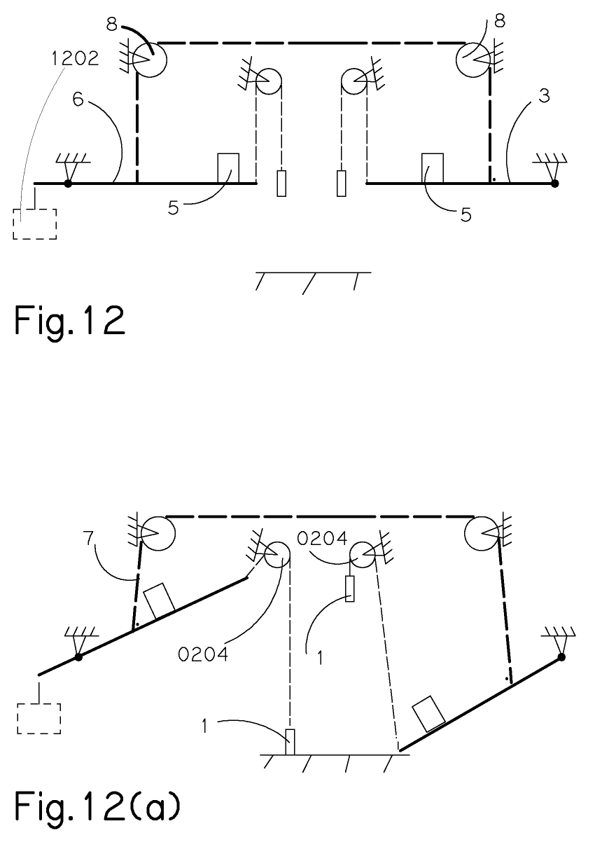

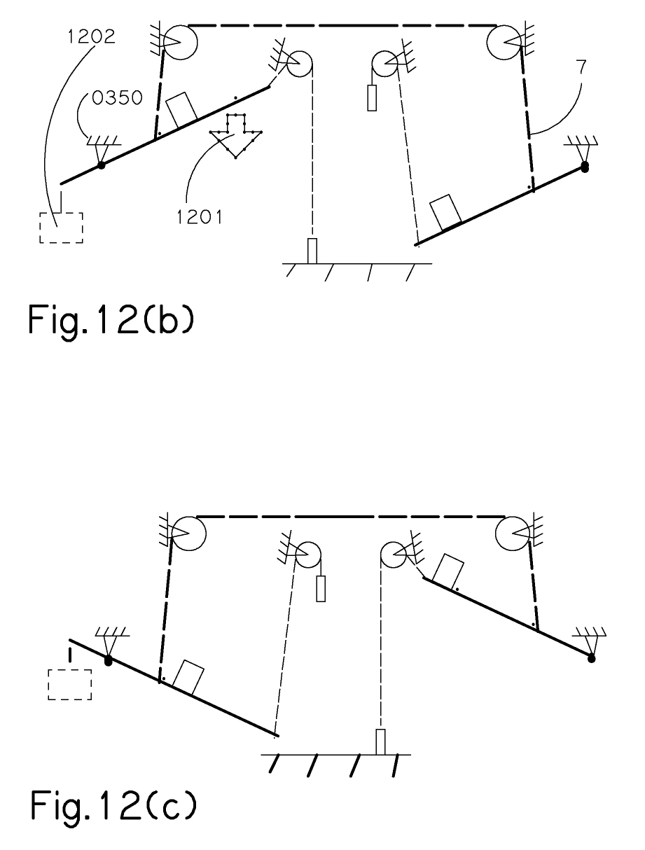

CALIBRATION PROCEDURE, before the start set up, is showed in rough sketch, schematic form, in FIG. 12. (as many following draws and presented in one same plane). First, the follower tank (13) must be water filled, (then anchor tank and sandbox tank, will be convenient ballasted also), both chained ends of slave beam (3) and master beam (6) must be a same level, by manipulating masses (5) position, as suggest the schematic in FIG. 12. That means pulley (8) system is in equilibrium also. (Only in these FIG. 12, all transfer balance elements, are represented as phantom box (1202), for simplicity).

SET UP, FOR CYCLE START, is showed in FIG. 12(a), sliding both masses (5) as suggested. Vacuum from O.W.C. (not showed) through pipeline (not showed) must be connected at rotating sealing elbow (1416). Both sprockets (0204) are ready to drive each end of dual shaft generator (2).

CYCLE STARTING is showed in FIG. 12(b), when the reactor (10) makes suction through his inlet (1007), (O.W.C. level going down (not showed)), in water from follower tank (13), and this water weight causes a downing force as suggested by arrow (1201). It is important recall that the unevenness of the reactor (10) optimizes the point where this force (liquid (1050) in FIG. 13 (d)) is applied. Such FIG. 13(d) shows liquid (1050) at leaning reactor (10) farthest end, causing best possible torsion around master beam (6) rotation axis (4).

Because this water weight was clinging in transfer balance (1202, box), in this FIG. 12(b), now this increases also the momentum around master beam (6) axis (4), (rod support (0350), causing elevation movement on jar (1) chained at that beam, which could be going down at this time. It is important also to notice some potential energy is stored, when ascend of the sandbox tank (18) takes place.

Also pulls down the coupling chain (7). That result in slave beam (3) elevation, letting going down at his chained jar (1) driving generator (2) shaft. (Remember: both ratchet sprockets (0204) are disposed to rotate the generator (2) dual shaft only when each jar (1) is falling).

CYCLE FINISHED, when master beam (6) returns at initial position, (showed in FIG. 12(B)). That is accomplished when master beam (6) touches the floor as depicted in FIG. 12 (c), when levitation lever (0606), receives pulling coming from cushioning action. This causes reactor (10) discharges liquid into follower tank (13), then returning the system at Cycle Start position. When is returning, jar (1) of the master beam (6) will be going down, driving the generator (2) shaft.

This manner, when the machine is running, always generator (2) will be rotating. (During this excursion time, O.W.C. liquid level (not showed) is going up.)

It is important also to notice that some potential energy is lost when sandbox tank (18) landing takes place. This energy is used to elevate the follower tank (13). Some necessary time delays are providing by chain curls formation, thanks at triggering capability.

ACCELERATION is an important item here, when beams start moving, that is when the beams ends start going down and when the beams ends start going up.

Structured form of transfer balance accomplishes that. (Next figures showed in same page, only for beam master (6) best angling comparison.)

FIG. 13 (schematic rough sketch) shows elements at initial position; just when master beam (6) begins to fall, after reactor (10) is charged, follower tank (13) is mostly empty. Hole (0612) will be going up, angled bar (16) also will have tendency to displace upward (but no rotates), and getting straight chain (20). Not additional weight on hole (0612), let we can say master beam (6) is in “free fall”.

FIG. 13(a) we see angled bar (16) rotated counterclockwise, because empty follower tank (13) has lost weight, letting less stress in chain (17), also we can see chain (20) now is fully stressed. (Reactor (10) shows here an exaggerated elevation).

At this point, we can say little weight is added at split radii ends, holes (0612). Then master beam (6) continues almost in free fall.

FIG. 13 (b) show the master beam (6) falling about half range. Now we are concerned about start braking the gravity accelerating action. Angled bar (16) rotation now is around stressed chain (20) top end, causing follower tank (13) is going down and beginning spring (28) stressing. Holder vertical bar (15) transmits counterclockwise momentum at rod support (0350).

FIG. 13(c) shows master beam at the range end. Levitation action (suggested by phantom curved arrow) causes liquid is returned at follower tank (13), adding his weight at hole (0612). Anyway sandbox (18) weight always is heavier than this liquid weight, then this differential will cause also an amplified counterclockwise momentum at rod support (0650), (because we have two rotation points at this time: in chain (20) end tied at angled bar (16), and in rod support (0350)). This situation is quite positive for fast master beam (6) end elevation starting.

In some cases, may be necessary install shocks absorbers (not showed) inside springs (28) to avoid undesirable vibrations. Another acceleration little aid comes from cables with springs (27), because at this position, are fully taut. See also FIG. 1 and FIG. 13 (d).

Behavior of this mechanism during return at initial position (as FIG. 13) is very similar, in reverted mode, with follower tank (13) weight, (now filled), having some influence, because sandbox tank (18) is much heavier causing follower tank (13) elevation. (When follower tank (13) is going up, angled bars (16) are counterclockwise rotating also around lower end of vertical bars (15), by balancing action caused by the sandbox (18) more heavy weight). Vacuum pump must have an internal spring (not showed) for keep piston normally near inlet (1417).

Shock absorber in slave beam (3) provides energy to vacuum pump (0309), when slave beam (3) touches the floor. Because small diameter of hose (1418) (showed partially in FIG. 6, but not in FIG. 1) and spring (0308) action (FIG. 2), causes a slight delay in vacuum application to manifold (14), giving time at follower tank (13) reach initial position, where the inlet (1007) of reactor (10), must be immersed, then this vacuum cleans any residual positive pressure build up.

Shock absorber in master beam (6) provides pulling action in levitation lever (0606) when master beam (6) touches the floor, causing reactor (10) rotation for discharge, assisted by pulling action from cable with spring (12), as explained before. In general, no weight values are included here, but such values must be set accordingly.

TIMING CONSIDERATIONS are necessary because Aperture is a tuned devise. Good performance is accomplished only playing with some variables. Mainly by sliding weight (mass (5)), water pumping between tanks (follower, sandbox, and jars) and anchor tank.)

Aperture cycle is designed for work around periods about 8-12 seconds range. By example (period of 10 seconds) when O.W.C is going down, first 5 seconds are used to reactor charging, (meanwhile master beam (6) jar (1) is going down, chain curl disappearing, which was formed when master beam end was going up), after solenoid triggering happens, moving down (O.W.C. start going up) the master beam (6) end using two seconds falling. When touches floor, reactor discharges during two seconds into follower tank (13) then master beam uses one second returning going up. During cycle development, slave beam (3) has reverted behavior and every jar (1) could have different falling time duration. (All time values estimated approximately). Of course, could exist many variants, and requires computed calculations, for each particular case. Because system asymmetry and inertial factors, slave beam (3) behavior is not an exact mirror function necessarily.

Near shores, waves periods are frequently less than 10 sec. and then triggering can be adjusted for every O.W.C. two periods. (And probably mixed with another variables adjusts).

O.W.C. variability, (in other words: ocean variability, mainly), suffers variations of wave period and amplitude (peak to peak), baseline variation (tide), plus a sort of waves of many frequencies arriving at same time on O.W.C., marine traffic causing wave train disruptions, etcetera plus the need of matching of power available on O.W.C. and the electrical service load (which also fluctuates around the clock), makes imperative use of automation, and this device is designed to nest (box (2504) in FIG. 11) a computer controlled system. That brings continuous variable tuning capability and with the added benefit of remote control operation, as telemetry, Internet, etc.

Software developed over specific characteristics of a particular beach or offshore conditions may be necessary in each particular case. Disregarding above considerations, some important requirements are obligatory: controlled cycle triggering capability, start up recovery capability (mainly with masses (5)), dynamic adjusting of weight of jars (1), follower tank (13), sandbox tank (18)) and falling velocity of jars (1) (Must be always less than velocity of beams chained ends (holes (0603), (0315)), thus manner forming chain curls.)

All that basic operations, must be fulfilled playing (with electric motors (0503)) with masses (5) positions, with levels of all liquid containers with bi-directional pumping with solenoids valves (not showed), and minor cycle triggering adjustments. Computed in accordance with vacuum sensor (1407), sensor plates (0313) working with sensors (not showed) located at holes (2510); and tanks liquid sensor levels (not showed) signaling, through electronic controller (not showed). All level sensors could require an additional small tube (not showed), acting as tranquility wells.

Computer controlled system let develop tasks over the pure electrical side also, as hesitation filtering, load limiting and controlling electric loads, as well as be programmed, allowing optimization of engine input/output energy availability. (Also could make some remote on-off outlet operations). Also it allows to play with generator (2) electric dynamic braking.

In case of big waves availability, pressurized air can be used for another distinct device, installing a set of two big check valves (not showed), between O.W.C. (not showed) output and Aperture pipeline input (not showed). That is possible because this engine only uses vacuum for reactor (10) operation.

And also a gearbox (not showed) can be used to drive generator (2), if multi-polarity generators are not adequate in particular cases. In some cases, structure parts itself could be used as vacuum conducts, (Not showed) including manifold (1412) replacement by axis (4) for strap (14) and hose (1417) attachment. (Not showed.) Also, an auxiliary spring (not showed) could be attached beneath reactor (10), near lower end, for help levitator action (aids rotating), of angled bar (0606).

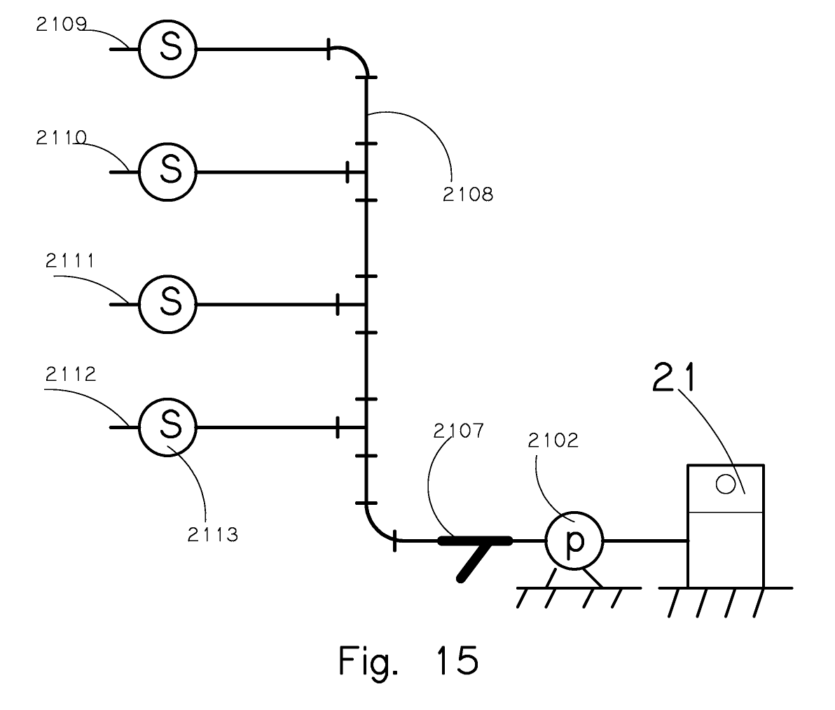

Intended primarily for sea operation, Aperture can operate at rivers (only in hydraulic fashion) replacing the actuator (reactor and transfer balance) with a hydraulic actuator, such as showed in schematic form in FIG. 14 where a pipe (1401) coming from river upstream, feeds an oscillating pan (1403), which discharges between split master beams (6) ends, (supported on (0350)) at fixed container (1406).

The precarious equilibrium given by the support with stopper (1402) helps instability introduced by the small levitator nail (1404) attached on such beam.

FIG. 14 (a) shows the hydraulic actuator, when is discharging water on the floor, going to downstream. Meanwhile, oscillating pan (1403) accumulates water. Arrows in both FIGS. 14 and 14(a) suggests water flow. Levitation action is not necessary in this case and must be disabled. (Discarding or stalling angled lever (0606)).

FIG. 15 is only a schematic diagram showing the anchor tank (21) with bi-directional pump (2102), feeding through filter Y (2107) and manifold (2108) (made up with 2 elbows and 3 tees), at four solenoid valves (2113) for routing to both jars (1), in generator (2) with outputs (2109,2110), to follower tank (13) with output (2111) and to sandbox tank (18) with output (2112), all liquid conducted with flexible hoses (not showed). Each solenoid valve must have at least one internal small circular filter and all must be electrically computer controlled, according with the sensors (not showed) information.

Modifying weight arrangement of jars (1) and generator (2), and (see FIG. 16) using beam ratchets (0402, 0403), acting over a rotating drive shaft (eliminating fixed axis (4) condition and using bearings (0401) at supports (0350)) is possible to use Aperture as rotational energy generator, to drive another devices, as a bucket elevator conveyor, for example. (Not showed).

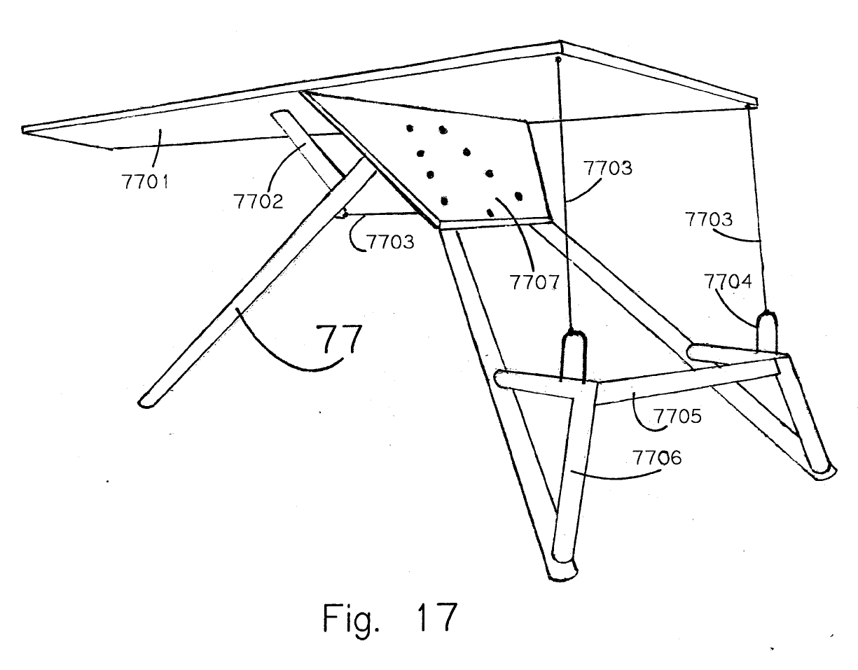

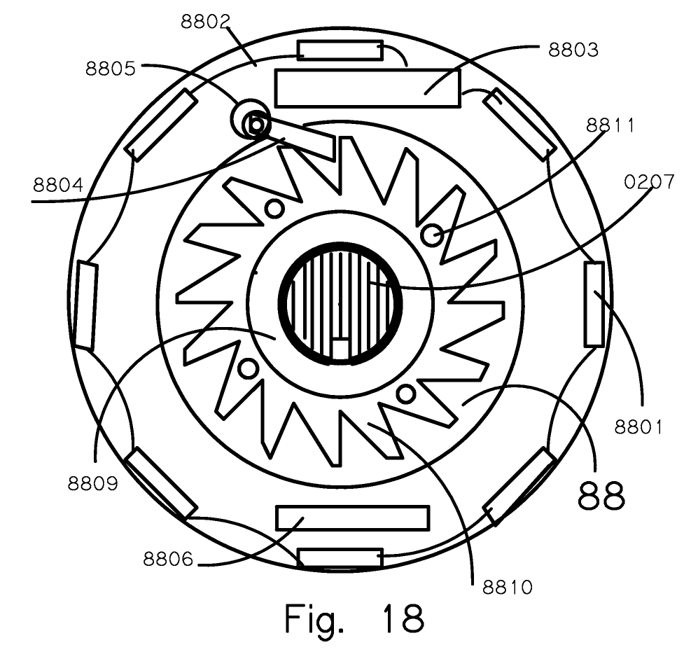

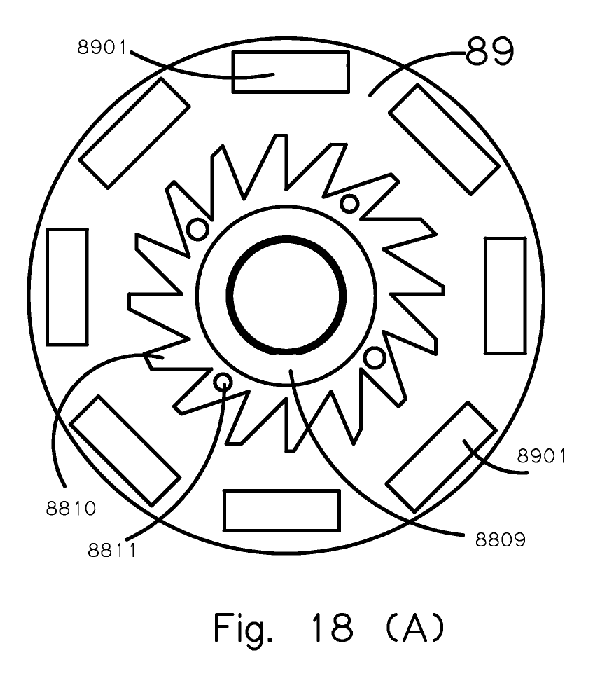

FIG. 17 shows a minimal structure for Aperture for portable use. A tripod (77) could hold top support (25), below narrow end of top trapezoid (7701), with brace (7702) and cable (7703) of stiffener plate (7707), tied both at tripod (77) leg, and angled bars (7706) with stabilizer (7706), through hooks (7704) and cables (7703) provides trapezoid (7701) stability help. And axis (4) can be located between hooks (7704). (Pillow blocks bearings can also be used in this case. (Not showed)). Disregarding of any structure form used, it must provide adequate floor supports for both crashing angled bars (0301).

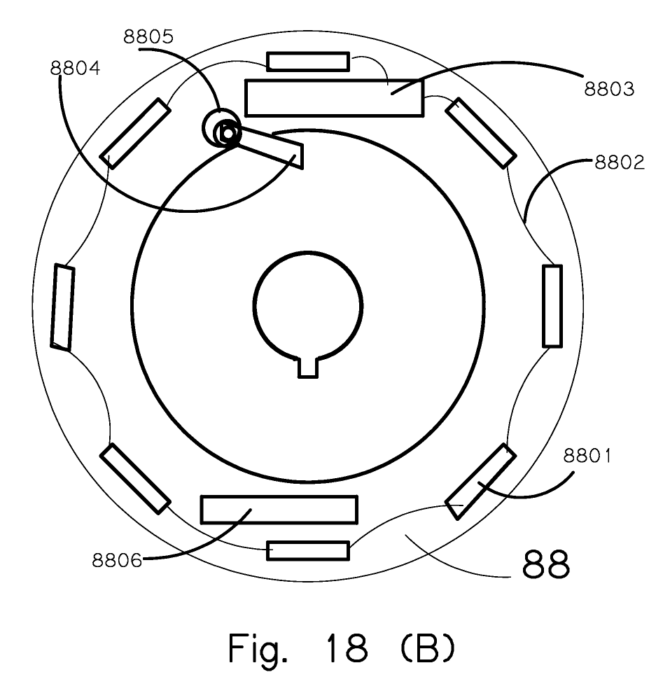

An electromagnetic ratchet (external), instead of internal ratchet of sprocket (0204), can be used for wearing and noise reduction, especially when devise operates continually. FIG. 18 shows plate (88) for coils (8801), with interconnecting wires (8802), an electromagnet box (8803), (which internally contains solenoid coil (not showed) and could have electronics parts (not showed) as ac/dc rectifier bridge, condensers, etc). Also has pawl (8804) with his spring (8805) and a counterbalance (8806). In plate (88) inner part, nests a ratchet gear (8810), attached at generator axis (0207) with a sealed ball bearing (8809).

FIG. 18 (A) shows magnets (8901) in magnet plate (89), which is screwed (screws not showed) using holes (8811), at ratchet gear (8810). These screws also could serve to hold simple sprocket (0204) located at the opposite side of magnet plate (89). FIG. 18 (B) shows coils plate (88) center hole, wedge ready (wedge not showed) to be attached on generator axis (0207).

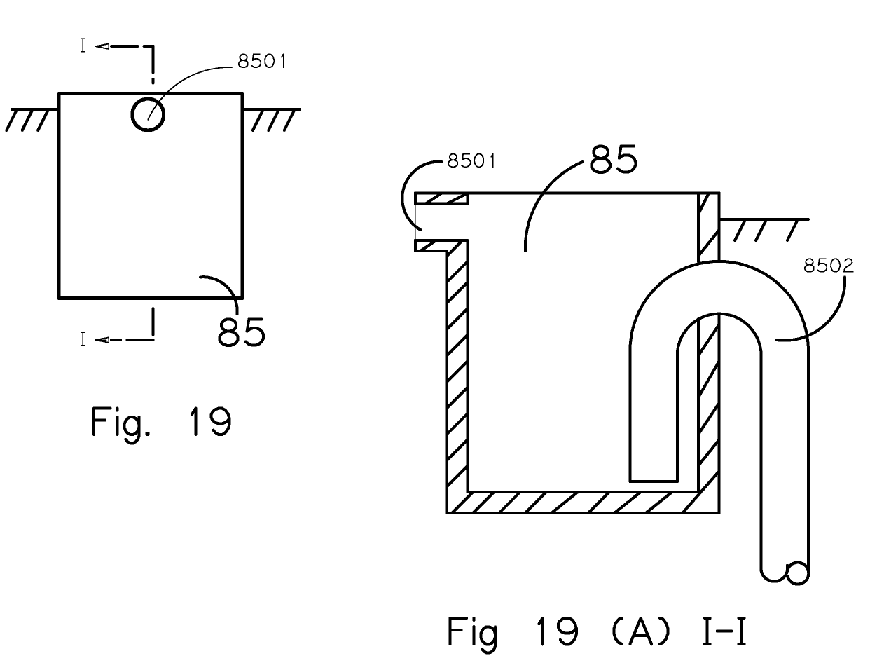

Aperture can be used in some lakes, with enough waves. And also in rivers, using the O.W.C. (not showed) into a wave emulator as showed in FIG. 19, made up with a sunken cylindrical tank (85), with self-priming siphoning (8502), as showed in FIG. 19(A) I-I where output flow must be twice than input flow (8501). Could require some regulator valves (not showed).

Aperture low requirements, more high capability and flexibility, make possible work mixed with public grid, and another renewable energy systems (wind, solar, etc). The conception of joint in site, atmospheric pressure with O.W.C. vacuum, and use of potential energy (as liquid weight displacement) incorporated in development of low pressure actuator, as a charge oscillator, plus only vacuum use in pipeline, with low loss energy transmission, opens new and wide ways to mankind to capture ocean vast energy supply, for this reason the interpretation of claims must be not construed only at the present description, only at the spirit of the Claims.

I claim:

1. A hydro pneumatic engine, comprising:
A supportive axis based on two points, having a simply rod supported slave beam and a simply rod supported master beam,
said slave beam, acting as first radius, further having his free end connected with a pulling chain at a cushioned cylindrical traveler tank, herein said pulling chain has links attached at a plurality of triangular blocks for triggering action, a swivel hook with a plate near in the middle length, an angled dual bar connected with a cable and a spring at a piston vacuum pump for cushioning, and a cover wherein an electric motor with two electric sensors using a long screw can displace a slid able internally threaded mass,
said master beam, bifurcated in one end, is divided by rod support in two unequal parts, defining a long radius and a short radius, which said short radius has two split ends, said long radius end further having a pulling chain connected at a cushioned cylindrical traveler tank, herein said pulling chain has links attached with a plurality of triangular blocks for triggering action, a cushioning angled dual bar connected with cable and spring at an angled lever levitator bar, said levitator bar is keep in position with two short springs attached at said master beam, near in the middle length a swivel hook with plate connects a coupling chain with said slave beam swivel hook, and a cover wherein an electric motor with two electric sensors using a long screw can displace a slide able internally threaded mass,
a hydro pneumatic actuator having a reactor and a transfer balance,
said Reactor hangs with three chains under said long radius and with a chain tied at lower end of said angled lever levitator bar, is a leaning elongated box with a down inlet with an internal absorptive tube with two rotating sealing, further having said absorptive tube connected externally through a manifold at a hose strap, said hose strap is connected at a resting manifold over bifurcated zone of said master beam long radius, herein said resting manifold has in one end an electric vacuum sensor and a rotating sealing for pipeline connector concentrically located with said supportive axis, and the other end has a reducer with internal check valve and a rotating sealing connected with flexible hose at said slave beam vacuum pump, and wherein both said manifolds includes a plurality of plumbing parts,
said Transfer Balance hangs from both split ends of said short radius, wherein each said split end further having a vertical bar, which lower end holds an angled bar, said angled bar is supporting at one end a follower tank herein an auxiliary spring with chain connects with said reactor and at the other end of said angled bar a spring with two chains holds one end of a cushioned sandbox tank, wherein a coupling plate attached between both said angled bars is chained at an anchor tank, wherein said anchor tank further having an electric sensor level and a bi-directional electric pump with output hose, wherein each said follower tank and sandbox tank is disposed to hold a hose end and an electric sensor for controlling liquid level, and wherein cables with strings connects top ends of said vertical bars with said angled bar ends which are close at said follower tank, herein said angled bar ends includes stopper small angled bars,
a top plate with fixing supporting holes, having a box disposed to contain a computer, an industrial controller, electric parts, back up battery and wirings to every said external electric component, a manifold to connect four electrical valves with flexible hoses to feed said two traveler tanks, sandbox tank and follower tank through a filter with said bi-directional electric pump output hose, a holder with two electric sensors and two pulleys for controlling and supporting said coupling chain, a dual axis electric generator herein two electric triggering devices controls the cycle engine, two sprockets with internal ratchets supports said pulling chains, and two hoses ends with two electric sensors controlling liquid levels of both said traveler tanks,
a housing supportive structure which provide weather protection, specially windshield and adequate entire engine supporting.

2. The hydro pneumatic engine according to claim 1,
wherein supportive axis based on two points further comprises supportive axis with bearings and ratchets into beams rod supports.

3. The hydro pneumatic engine according to claim 1, wherein sprockets with internal ratchets further comprises sprockets with external self-electromagnetic ratchets.

4. The hydro pneumatic engine according to claim 1, wherein the hydro pneumatic actuator further comprises a hydraulic actuator being an oscillating pan discharging liquid over a tank fixed under master beam long radius.
